(19) United States
(12) Patent Application Publication
(10) Pub. No.: US 2013/0045912 A1
(43) Pub. Date: Feb. 21, 2013

(54) Colored Polyester

(71) Applicants: Roman Morschhaeuser, Mainz (DE); Barbara Duecker, Mainz (DE); Hans Juergen Scholz, Alzenau (DE); Uwe Bechtold, Frankfurt am Main (DE)

(72) Inventors: Roman Morschhaeuser, Mainz (DE); Barbara Duecker, Mainz (DE); Hans Juergen Scholz, Alzenau (DE); Uwe Bechtold, Frankfurt am Main (DE)

(73) Assignee: CLARIANT FINANCE (BVI) LIMITED, Tortola (VG)

(21) Appl. No.: 13/637,489

(22) PCT Filed: Mar. 23, 2011
(86) PCT No.: PCT/EP2011/001456

§ 371 Date: Oct. 30, 2012

(30) Foreign Application Priority Data
Mar. 27, 2010 (DE) 10 2010 013 135.0

(51) Int. Cl. C11D 3/60

(52) U.S. Cl. 510/400

(57) ABSTRACT

The invention relates to colored polyester in solid form, characterized in that the colored polyester is obtained by polymerizing components comprising a) one or more aromatic dicarbolic acids having no sulfogroups and/or the salts thereof and/or the anhydrides thereof and/or the esters thereof, b) optionally one or more dicarbolic acids having sulfogroups and/or the salts thereof and/or the anhydrides thereof and/or the esters thereof, c) one or more dioles, d) optionally one or more compounds of the formula (1)

R¹O(CHR²CHR³O)ₙH (1)

where R¹ is a linear or branched, saturated or unsaturated alkyl group having 1 to 22 C atoms, R² and R³ are, independent of each other, hydrogen or an alkyl group having 1 to 4 carbon atoms, and n is a number from 1 to 50, e) optionally one or more compounds of the formula (2)

H—(OCHR²CHR³)ₘ—SO₃X (2)

where R² and R³ are, independent of each other, hydrogen or an alkyl group having 1 to 4 carbon atoms, and m is a number from 1 to 10, and X is hydrogen or an alkali metal ion, and f) optionally one or more polyfunctional compounds having a crosslinking effect and having 3 to 6 functions enabled for polycondensation, in particular acid, alcohol, or ester functions, under the condition that at least one of the components d) or e) is present, in the presence of g) one or more pigment(s).

The invention relates to colored polyesters which have good water solubility, excellent dispersion capacity, good soil release action and strong graying-inhibiting action, but at the same time do not show any tendency to stain surfaces such as textiles, plastic, ceramic, wood or else skin. Compositions comprising these colored polyesters can be washed off with water without leaving a residue.

Polyesters of aromatic dicarboxylic acids, such as terephthalic acid or isophthalic acid, and sulfonated aromatic dicarboxylic acids, such as sulfoisophthalic acid, and diols, such as alkylene glycol, are described as soil release polymers (SRPs) in washing and cleaning compositions. These polyesters usually have a yellowish to gray-beige appearance and often do not meet the aesthetic demands of the consumer.

DE-A-10 2007 051279 claims dye mixtures which can be washed off, comprising nonionic polyesters, and emphasizes the excellent coloring thereby, especially in polar formulations such as laundry and dishwashing detergents with simultaneously low propensity to stain the textiles and surfaces.

It was an object of the present invention to provide polyesters with good soil release action in solid form in various colors which do not cause any discoloration of compositions, especially of liquid compositions, and do not exhibit any tendency to be attracted to and to adhere to textiles, hard surfaces such as plastic, ceramic, wood, or else to skin. In addition, the solid polyesters should also have good solubility in water even at low temperatures and not cause any significant discoloration of the aqueous solution.

Mixing of conventionally produced soil release polyesters with pigments or dyes is technically complex and leads to very inhomogeneous, discolored polyester particles with dye or pigment lumps of dark appearance. These cause inhomogeneous discoloration on surfaces. Transparent polyester particles comprising pigments in very low concentrations and homogeneous distribution of the pigments cannot be produced in this way.

It has been found that, surprisingly, very homogeneously colored and simultaneously transparent polyesters are obtained by performing the condensation of the monomers in the presence of pigments. The pigment particles are present in ultrafine distribution in the polymeric condensation product. The cooled polymer melts thus obtained, and also the ground products thereof, show a brilliant colored and transparent appearance without any visible, inhomogeneously distributed pigment accumulations and lumps. The colored polyesters obtained in accordance with the invention do not exhibit any tendency whatsoever to adhere to textiles in the wash liquor, and can be rinsed off textile fibers without leaving a residue.

The invention provides colored polyesters in solid form, wherein the colored polyesters are obtained by polymerizing components comprising

a) one or more sulfo-free aromatic dicarboxylic acids and/or salts thereof and/or anhydrides thereof and/or esters thereof,

b) optionally one or more sulfo-containing dicarboxylic acids, salts thereof and/or anhydrides thereof and/or esters thereof,

c) one or more diols,

d) optionally one or more compounds of the formula (1)

R¹O(CHR²CHR³O)ₙH (1)
where
is a linear or branched, saturated or unsaturated alkyl group having 1 to 22 carbon atoms, preferably methyl,
R² and R³ are each independently hydrogen or an alkyl group having 1 to 4 carbon atoms, preferably hydrogen and/or methyl and
n is a number from 1 to 50, preferably 2 to 10,

e) optionally one or more compounds of the formula (2)

H—(OCHR²CHR³)ₘ—SO₃X (2)
where
R² and R³ are each independently hydrogen or an alkyl group having 1 to 4 carbon atoms, preferably hydrogen and/or methyl and
m is a number from 1 to 10, preferably 1 to 5, and
X is hydrogen or an alkali metal ion, and

f) optionally one or more crosslinking polyfunctional compounds having 3 to 6 functions capable of polycondensation, especially acid, alcohol or ester functions,
with the proviso that at least one of components d) and e) is present, in the presence of

g) one or more pigment(s).

A preferred embodiment of the invention encompasses colored anionic polyesters as defined above, comprising at least one of components b) and e), i.e. comprising at least one sulfo group.

A particularly preferred embodiment of the invention encompasses colored anionic polyesters as defined above, comprising components a), b), c), d), optionally e), optionally f), and g).

Preferred components a) are one or more compounds selected from terephthalic acid, phthalic acid, isophthalic acid, anhydrides thereof, and the mono- and dialkyl esters thereof with C₁—C₆-alcohols of these dicarboxylic acids. Particularly preferred components a) are one or more compounds selected from terephthalic acid, isophthalic acid, and the dimethyl, diethyl, dipropyl and dibutyl esters thereof.

Preferred components b) are one or more compounds selected from the alkali metal/alkaline earth metal or ammonium salt of 2-naphthyl-dicarboxybenzenesulfonate, 1-naphthyldicarboxybenzenesulfonate, phenyldicarboxybenzenesulfonate, 2,6-dimethylphenyl-3,5-dicarboxy-benzenesulfonate, phenyl-3,4-dicarboxybenzenesulfonate and 5-sulfoisophthalic acid, anhydrides thereof, and the mono- and dialkyl esters thereof with C₁—C₆-alcohols. Particularly preferred components b) are one or more compounds selected from dialkyl 5-sulfoisophthalate, especially dimethyl 5-sulfoisophthalate, lithium and sodium salts, or mono-, di-, tri- or tetraalkylammonium salts with C₁- to C₂₂-alkyl radicals.

Preferred components c) are one or more compounds selected from ethylene glycol, propylene glycol, i-propylene glycol, n-butylene glycol, i-butylene glycol, t-butylene glycol, diethylene glycol, triethylene glycol, tetraethylene glycol, pentaethylene glycol, hexaethylene glycol, heptaethylene glycol, octaethylene glycol, dipropylene glycol, tripropylene glycol, polyethylene glycols having molecular weights of approx. 600 to 8000 g/mol, and also polypropylene glycols having molecular weights of approx. 600 to 8000 g/mol and polypropylene ethyl glycol having molecular weights of approx. 600 to 8000 g/mol.

Preferred component(s) d) is/are one or more compounds from the group of the singly end-capped polyalkylene glycols (end blocking), preferably polyethylene glycol monoalkyl ethers or poly[ethylene glycol-co-propylene glycol]monoalkyl ethers having mean molecular weights of approx. 150 to 2000 g/mol.

Particularly preferred components d) are one or more compounds of the formula (1a) CH₃—O—(C₂H₄O)ₙ—H where n=2 to 50, preferably 2 to 10, more preferably where n=3 to 5.

Preferred compounds of component e) are those of the formula (2a)

p H—(OCH₂CH₂)ₘ—SO₃X (2a),

where

m is a number from 1 to 4, more preferably 1 or 2, and

X is hydrogen, sodium or potassium.

Compounds of component f) are crosslinking polyfunctional compounds having 3 to 6 functional groups capable of an esterification reaction, for example acid, alcohol, ester, anhydride or epoxy groups. Different functionalities are also possible in one molecule. Preferred examples here include citric acid, malic acid, tartaric acid and gallic acid, more preferably 2,2-dihydroxymethylpropionic acid.

In addition, it is possible to use polyhydric alcohols such as pentaerythritol, glycerol, sorbitol and trimethylolpropane.

Additionally preferred are polybasic aliphatic and aromatic carboxylic acids such as benzene-1,2,3-tricarboxylic acid (hemimellitic acid), benzene-1,2,4-tricarboxylic acid (trimellitic acid), more preferably benzene-1,3,5-tricarboxylic acid (trimesic acid).

Furthermore, the inventive polyesters, in addition to the above-described components a) to f), may comprise structural elements of an aliphatic dicarboxylic acid, preferably 1,4-cyclohexanedicarboxylic acid, oxalic acid, succinic acid, glutaric acid, adipic acid, fumaric acid, maleic acid, itaconic acid.

The proportion by weight of the aliphatic dicarboxylic acid used may be 1 to 15%, preferably 3 to 10%, more preferably 5 to 8%, based on the total amount of the monomers used.

Preference is given to polyesters obtainable by polymerizing components a) to f) in the following molar ratios, based on 1 mol of component a):

0 to 4 mol, preferably 0.1 to 2 mol, especially 0.2 to 1.5 mol and most preferably 0.3 to 1.1 mol of component b),

0.1 to 4 mol, preferably 0.5 to 3 mol, especially 0.6 to 2.5 mol and most preferably 0.8 to 1.5 mol of component c),

0 to 4 mol, preferably 0.2 to 2 mol, especially 0.3 to 1.0 mol and most preferably 0.3 to 0.8 mol of component d),

0 to 4 mol, preferably 0.2 to 2 mol, especially 0.2 to 1.0 mol and most preferably 0.3 to 0.8 mol of component e),

0 to 0.2 mol, preferably 0 to 0.1 mol and especially 0 mol of component f), with the proviso that at least one of components d) and e) is present.

Particular preference is also given to polyesters obtainable by polymerizing components a) to f) in the following molar ratios, based on 1 mol of component a):

0.1 to 2 mol, especially 0.2 to 1.5 mol and most preferably 0.3 to 1.1 mol of component b),

0.1 to 4 mol, preferably 0.5 to 3 mol, especially 0.6 to 2.5 mol and most preferably 0.8 to 1.5 mol of component c),

0 to 4 mol, preferably 0.2 to 2 mol, especially 0.3 to 1.0 mol and most preferably 0.3 to 0.8 mol of component d),

0 to 4 mol, preferably 0.2 to 2 mol, especially 0.2 to 1.0 mol and most preferably 0.3 to 0.8 mol of component e),

0 to 0.2 mol, preferably 0 to 0.1 mol and especially 0 mol of component f), with the proviso that at least one of components d) and e) is present.

Very particular preference is given to polyesters obtainable by polymerizing components a) to f) in the following molar ratios, based on 1 mol of component a):

0.1 to 2 mol, especially 0.2 to 1.5 mol and most preferably 0.3 to 1.1 mol of component b),

0.1 to 4 mol, preferably 0.5 to 3 mol, especially 0.6 to 2.5 mol and most preferably 0.8 to 1.5 mol of component c),

0.2 to 2 mol, especially 0.3 to 1.0 mol and most preferably 0.3 to 0.8 mol of component d),

0 to 4 mol, preferably 0.2 to 2 mol, especially 0.2 to 1.0 mol and most preferably 0.3 to 0.8 mol of component e),

0 to 0.2 mol, preferably 0 to 0.1 mol and especially 0 mol of component f).

The polyesters generally have number-average molecular weights in the range from 700 to 50 000 g/mol, preferably from 800 to 25 000 g/mol, especially 1000 to 15 000 g/mol, more preferably 1200 to 12 000 g/mol. The number-average molecular weight is determined by means of size exclusion chromatography in aqueous solution using calibration with the aid of narrow-distribution polyacrylic acid sodium salt standard.

All molecular weight data in this document relates to the number-average molecular weight.

The inventive colored polyesters are obtained by polymerizing the abovementioned components a) to f), and it is essential to the invention that the pigment component g) is added to the reaction mixture before or during the polymerization process.

Useful components g) include all color pigments from the group of the inorganic pigments, organic pigments and effect pigments.

By definition, pigments, in contrast to dyes, are virtually insoluble in the application medium.

Preferred organic pigments are monoazo, disazo, laked azo, β-naphthol, naphthol AS, benzimidazolone, disazo condensation, azo metal complex pigments and polycyclic pigments such as, for example, phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments.

Among the organic pigments mentioned, particularly suitable pigments are those which are in very fine distribution, with preferably 95% and more preferably 99% of the pigment particles having a particle size of ≦500 nm. Appropriately, the pigment particles have a d₅₀ between 50 and 500 nm, preferably between 70 and 350 nm.

An illustrative selection of particularly preferred organic pigments includes monoazo and disazo pigments, especially the Color Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83,

Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Yellow 219, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and naphthol AS pigments, especially the Color Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, especially the Color Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, especially the Color Index pigments Pigment Yellow 120, Pigment. Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72, Pigment Blue 80 or Pigment Brown 25; isoindolinone and isoindoline pigments, especially the Color Index pigments Pigment Yellow 139 or Pigment Yellow 173; phthalocyanine pigments, especially the Color Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthraquinone, quinacridone, dioxazine, indanthrone, perylene, perinone and thioindigo pigments, especially the Color Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 and Pigment Orange 43; triarylcarbonium pigments, especially the Color Index pigments Pigment Red 169, Pigment Blue 56 or Pigment Blue 61; diketopyrrolopyrrole pigments, especially the Color Index pigments Pigment Red 254, Pigment Red 255, Pigment Red 264, Pigment Red 270, Pigment Red 272, Pigment Orange 71, Pigment Orange 73, Pigment Orange 81.

Preferred inorganic pigments are, for example, titanium dioxides, zinc sulfides, zinc oxides, iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed phase pigments, sulfides of the rare earths, spinels of cobalt with nickel and zinc, spinels based on iron and chromium with copper, zinc and manganese, bismuth vanadates and extender pigments, especially the Color Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17. Preference is also given to mixtures of inorganic pigments and mixtures of organic with inorganic pigments.

Pigment component g) can be used as a powder pigment, as a presscake, as a dispersion, as a solid pigment formulation or as a liquid pigment preparation. Preference is given to aqueous glycol-containing pigment dispersions or preparations.

In all aforementioned embodiments, the inventive polyesters comprise pigment component g), based on dry pigment, in amounts of 10⁻⁶ to 5% by weight, preferably 10⁻⁵ to 1% by weight, more preferably 10⁻⁴ to 0.5% by weight, based on 100% by weight of colored polyester.

The colored polyesters are prepared by processes known per se, by polycondensation of components a) to f) in the presence of pigment component g). Appropriately, the abovementioned components a) to f), with addition of a catalyst, are heated at first at standard pressure to temperatures of 160 to approx. 220° C. using an inert atmosphere, preferably in the presence of a salt of a C₁—C₃-alkylcarboxylic acid, especially a dehydrated or partially hydrated sodium acetate CH₃COONa×(H₂O)ₓ where ₓ is a number in the range from 0 to 2.9, and where this salt is used in amounts by weight of 0.5 to 30%, preferably of 1 to 15% and more preferably of 3 to 8%, based on the total amount of the monomers used and the salt of the carboxylic acid. Preferably, the pigment component g) is added at this time. Then the required molecular weights are built up under reduced pressure at temperatures of 160 to approx. 240° C. by distillative removal of overstoichiometric amounts of the glycols used. Suitable catalysts for the reaction are known prior art transesterification and condensation catalysts, for example titanium tetraisopropoxide, dibutyltin oxide, alkali metal or alkaline earth metal alkoxides or antimony trioxide/calcium acetate.

In a preferred process for preparing the inventive colored polyesters, the condensation of the components is performed in a one-pot process, with addition of the transesterification and condensation catalysts prior to heating.

The colored polyesters are obtained as a melt in the synthesis, which is solidified to flakes by cooling in a cool gas stream, for example an air or nitrogen stream, or preferably by application to a flaking roll or to a conveyor belt at 40 to 80° C., preferably at 45 to 55° C. This coarse material is appropriately ground to the desired final particle size of preferably 10 to 150 μm, which may optionally be followed by sieving to remove oversize.

Suitable grinding apparatus includes a number of mills which work preferably by the principle of impact comminution. For example, hammer mills, pinned disk mills or jet mills are conceivable, these optionally being equipped with an integrated sifter for an upper limit on the particle size. The grinding fineness of the powder can be varied without any problem by varying typical operating parameters (mill speed, throughput), for example from d90,3=10 μm to d90,3=150 μm.

In a further preferred embodiment, the ground powder can be converted to pellets by compaction, with or without addition of further additives. The compaction of the powder material is preferably conducted on roll compactors (for example from Hosokawa-Bepex, Alexanderwerk, Koppern). Through the choice of the roll profile, it is possible to produce pieces or briquettes on the one hand, and slugs on the other hand. The slugs are subsequently comminuted in a mill to pellets with the desired particle size of approx. 100-1600 μm.

Pelletization can also be effected by means of buildup pelletization in a mixer.

The pelletization, especially the pelletization of the polyesters with additives, can be effected in customary mixing apparatus which works batchwise or continuously, and is generally equipped with rotating mixing elements. The mixers used may be moderate intensity apparatuses, for example plowshare mixers (Lödige KM types, Drais K-T types), but also intensive mixers (e.g. Eirich, Schugi, Lodige CB types, Drais K-TT types). Polyesters and additives can be mixed simultaneously. However, also conceivable are multistage mixing processes in which the polyesters and additives are introduced into the overall mixture in various combinations, individually or together with other additives. The sequence of slow and fast mixers can be switched as required. The residence times in the mixer pelletization are preferably 0.5 s to 20 min, more preferably 2 s to 10 min.

In a further embodiment, the pelletization is effected by shaping pelletization. An additive is added to the ground polyester powder, such that the mixture is in homogeneous form as a plasticizable material. The mixing step can be effected in the abovementioned mixing apparatus, but kneaders or specific extruder types (e.g. Extrud-o-mix® from Hosokawa-Bepex Corp.) are also conceivable. The pelletization material is subsequently pressed by means of tools through the die bores of a press die, so as to form cylinder-shaped extrudates. Suitable apparatuses for the extrusion operation are preferably edge-runner presses (for example from Schluter), or edge runners (for example from Amandus-Kahl), and in some cases also extruders in the form of a single-shaft machine (for example from Hosokawa-Bepex, Fuji-Paudal) or preferably of a twin-screw extruder (for example from Händle). The choice of diameter of the die bore depends on the individual case and is typically in the range of 0.7-4 mm.

Useful additives preferably include anhydrous products such as fatty alcohols, C₈—C₃₁ fatty alcohol polyalkoxylates with 1 to 100 mols of EO, C₃—C₃₁ fatty acids (e.g. lauric acid, myristic acid, stearic acid), dicarboxylic acids, for example glutaric acid, adipic acid or anhydrides thereof, anionic or nonionic surfactants, waxes, silicones, anionic and cationic polymers, homopolymers, copolymers or graft copolymers of unsaturated carboxylic acids and/or sulfonic acids and the alkali metal salts thereof, cellulose ethers, starch, starch ethers, polyvinylpyrrolidone;

mono- or polybasic carboxylic acids, hydroxycarboxylic acids or ether carboxylic acids each having 3 to 8 carbon atoms and salts thereof; and polyalkylene glycols. Useful polyalkylene glycols include polyethylene glycols, 1,2-polypropylene glycols and modified polyethylene glycols and polypropylene glycols. The modified polyalkylene glycols include especially sulfates and/or disulfates of polyethylene glycols or polypropylene glycols having a relative molecular mass between 600 and 12 000 and especially between 1000 and 4000. A further group consists of mono- and/or disuccinates of the polyalkylene glycols, which in turn have relative molecular masses between 600 and 6000 g/mol, preferably between 1000 and 4000 g/mol. In addition, ethoxylated derivatives such as trimethylolpropane with 5 to 30 EO are also included.

Depending on the chemical properties, the additives can be used in solid form, as a melt or as aqueous solutions.

The colored polyester pellets may contain 0 to 30% by weight of one or more of the additives mentioned, preferably 0 to 25% by weight and more preferably 0 to 20% by weight, based on the colored polyester pellets.

The inventive colored polyesters can also be supplied as a mixture with hydrotropes from the group of the fatty alcohol sulfates, alkyl sulfates, a-olefinsulfonates, preference being given to alkylarylsulfonates and arylsulfonates, especially cumene-, toluene- and xylenesulfonates and mixtures thereof. If they are present, the proportion of hydrotropes is appropriately from 0.1 to 15% by weight, preferably 1 to 10% by weight, based on the polyester solids.

The inventive colored polyesters have an extremely low staining potential on skin, clothing and hard surfaces and have very good water solubility. Formulations comprising these colored polyesters are easy to wash off without leaving a residue.

The invention further provides for the use of the inventive colored polyesters in washing and cleaning compositions.

The washing and cleaning composition formulations in which the inventive colored polyesters can be used are pulverulent or granular.

Examples thereof are heavy duty laundry detergents, light duty laundry detergents, color laundry detergents, wool laundry detergents, curtain laundry detergents, modular laundry detergents, laundry tablets, bar soaps, stain removal salts, laundry starches and stiffeners, ironing aids.

The inventive colored polyesters can thus also be incorporated into household cleaning compositions, for example all-purpose cleaners, dishwashing detergents, rinse aids, carpet cleaning and impregnating compositions, cleaning and care compositions for floors and other hard surfaces, for example of plastic, ceramic, glass or nanoparticle-coated surfaces. Examples of technical cleaning compositions are plastics cleaning compositions and care compositions, for instance for housings and dashboards, and also cleaning and care compositions for painted surfaces, for instance automotive bodywork.

Washing and cleaning composition formulations contain preferably at least 0.01% by weight, preferably between 0.1 and 10% by weight and more preferably 0.2 to 3% by weight of the inventive colored polyesters, based on the total weight of the washing and cleaning composition formulations.

According to their envisaged use, the composition of the formulations should be adjusted to the nature of the textiles to be treated or washed, or of the surfaces to be cleaned.

The inventive washing and cleaning compositions may comprise standard ingredients such as surfactants, emulsifiers, builders, bleach catalysts and activators, sequestrants, graying inhibitors, dye transfer inhibitors, dye fixatives, enzymes, optical brighteners and softening components. In addition, formulations or parts of the formulation can be selectively colored and/or perfumed by dyes and/or fragrances.

### Example 1: Polyester 1

A 2 l four-neck flask with precision glass stirrer, internal thermometer, gas inlet tube and distillation apparatus was initially charged with 281.5 g of 1,2-propanediol (3.71 mol), 229.6 g of ethylene glycol (3.70 mol), 250 g of PEG-250 monomethyl ether, 970.9 g (5.00 mol) of dimethyl terephthalate and 236.98 g (0.8 mol) of dimethyl 5-sulfoisophthalate sodium salt, and the reaction mixture was then inertized by introduction of N₂. Subsequently, 1 g of titanium tetraisopropoxide and 0.8 g of sodium acetate were added to the reaction mixture against an opposing gas flow. The mixture was heated gradually on an oil bath, and the solid components started to melt from internal temperature about 120-150° C. The mixture was then heated to 190° C. within 30 min while stirring. At approx. 173° C., the transesterification or distillation commenced. Over the course of 2 h hours, the internal temperature was increased to 210° C. until the amount of condensate required according to the stoichiometry had been attained. Under protective gas, after the transesterification reaction had ended and with slight lowering of the internal temperature to 190° C., the required amount of Pigment Blue 15:3 (0.2% by weight based on the calculated polymer weight as a 40% dispersion in propylene glycol) was added to the reaction mixture.

Thereafter, the oil bath temperature was increased to approx. 240 to 250° C. and the internal pressure was lowered to the best possible oil-pump vacuum within 30 minutes. During the three-hour vacuum phase, the condensation was completed by distilling off the excess amount of alcohol. During this time, the internal temperature of the polyester melt increased gradually up to about 220° C. at the end of the reaction. Thereafter, N₂ was admitted and the melt was discharged onto metal sheets. The result was a deep blue polymer melt.

### Example 2: Polyester 2

A 3 l four-neck flask with precision glass stirrer, internal thermometer, gas inlet tube and distillation apparatus was initially charged with 418.5 g of 1,2-propanediol, 279.3 g of ethylene glycol, 212.4 g of tetraethylene glycol monomethyl ether, 1359.3 g of dimethyl terephthalate and 29.6.22 g of dimethyl 5-sulfoisophthalate sodium salt and 250 g of polyethylene glycol 250, and the reaction mixture was then inertized by introduction of N₂. Subsequently, 1.5 g of sodium methoxide and 0.5 g of sodium carbonate were added to the reaction mixture against an opposing gas flow. The mixture was heated gradually on an oil bath, and the solid components started to melt from internal temperature about 120-150° C. The mixture was then heated to 190° C. within 30 min while stirring. At approx. 173° C., the transesterification or distillation commenced. Over the course of 2 h hours, the internal temperature was increased to 210° C. until the amount of condensate required according to the stoichiometry had been attained. Under protective gas, after the transesterification reaction had ended and with slight lowering of the internal temperature to 190° C., the required amount of Pigment Red 122 (0.1% by weight based on the calculated polymer weight as a 40% dispersion in propylene glycol) was added to the reaction mixture.

Thereafter, the oil bath temperature was increased to approx. 240 to 250° C. and the internal pressure was lowered to the best possible oil-pump vacuum within 30 minutes. During the three-hour vacuum phase, the condensation was completed by distilling off the excess amount of alcohol.

During this time, the internal temperature of the polyester melt increased gradually up to about 220° C. at the end of the reaction. Thereafter, N₂ was admitted and the melt was discharged onto metal sheets. The result was a pink-red polymer melt.

### Example 3: Polyester 3

A 3 l four-neck flask with precision glass stirrer, internal thermometer, gas inlet tube and distillation apparatus was initially charged with 281.5 g of 1,2-propanediol, 223.4 g of ethylene glycol, 202 g of triethylene glycol monomethyl ether, 582.5 g of dimethyl terephthalate and 296.22 g of dimethyl 5-sulfoisophthalate sodium salt, and the reaction mixture was then inertized by introduction of N₂. Subsequently, 1.02 g of titanium tetraisopropoxide and 0.8 g of sodium acetate were added to the reaction mixture against an opposing gas flow. The mixture was heated gradually on an oil bath, and the solid components started to melt from internal temperature about 120-150° C. The mixture was then heated to 195° C. within 45 min while stirring. At approx. 173° C., the transesterification or distillation commenced. Over the course of 3 h hours, the internal temperature was increased to 210° C. until the amount of condensate required according to the stoichiometry had been attained. Under protective gas, after the transesterification reaction had ended and with slight lowering of the internal temperature to 190° C., the required amount of Pigment Violet 23 (0.1% by weight based on the calculated polymer weight as a 40% dispersion in propylene glycol) was added to the reaction mixture.

Thereafter, the oil bath temperature was increased to approx. 240-255° C. and the internal pressure was lowered to <20 mbar within 60 minutes. During the four-hour vacuum phase, the condensation was completed by distilling off the excess amount of alcohol. During this time, the internal temperature of the polyester melt increased gradually up to 225° C. at the end of the reaction. Thereafter, N₂ was admitted and the melt was discharged onto metal sheets. The result was a violet polymer melt.

### Example 4: Polyester 4

### Reaction Conducted as per Example 2

| | | | |
|---|---|---|---|
| Components: | 281.5 | g | 1,2-propanediol |
| | 223.4 | g | ethylene glycol |
| | 776.7 | g | dimethyl terephthalate |
| | 355.5 | g | dimethyl 5-sulfoisophthalate sodium salt |
| | 295.5 | g | tallow fatty alcohol with 8 units of ethylene oxide |
| | 1.00 | g | titanium tetraisopropoxide |
| | 0.8 | g | sodium acetate |
| | 1 | g | C.I. Pigment Red 254 |

### Example 5: Polyester 5

### Reaction Conducted as per Example 3

| | | | |
|---|---|---|---|
| Components: | 620.6 | g | ethylene glycol |
| | 970.9 | g | dimethyl terephthalate |
| | 444.3 | g | dimethyl 5-sulfoisophthalate sodium salt |
| | 162 | g | triethylene glycol monobutyl ether |
| | 1.00 | g | titanium tetraisopropoxide |
| | 0.8 | g | sodium acetate |
| | 0.1 | g | C.I. Pigment Red 254 |

### Example 6: Polyester 6

### Reaction Conducted as per Example 1

| | | | |
|---|---|---|---|
| Components: | 152.2 | g | 1,2-propanediol |
| | 124.1 | g | ethylene glycol |
| | 388.3 | g | dimethyl terephthalate |
| | 177.7 | g | 5-sulfoisophthalic acid lithium salt |
| | 100 | g | lauryl alcohol with 7 units of ethylene oxide |
| | 1.00 | g | titanium tetraisopropoxide |
| | 0.5 | g | C.I. Pigment Yellow 122 |

### Example 7: Polyester 7

### Reaction Conducted as per Example 1

| | | | |
|---|---|---|---|
| Components: | 422.3 | g | 1,2-propanediol |
| | 335.1 | g | ethylene glycol |
| | 873.8 | g | dimethyl terephthalate |
| | 177.7 | g | 5-sulfoisophthalic acid sodium salt |
| | 100 | g | triethylene glycol monomethyl ether |
| | 50 | g | polyethylene glycol 500 |
| | 50 | g | polyethylene glycol 1500 |
| | 1.00 | g | titanium tetraisopropoxide |
| | 0.01 | g | C.I. Pigment Green 36 |

### Example 8: Polyester 8

### Reaction Conducted as per Example 1

| | | | |
|---|---|---|---|
| Components: | 380.5 | g | 1,2-propanediol |
| | 186.2 | g | ethylene glycol |
| | 873.8 | g | dimethyl terephthalate |
| | 444.3 | g | 5-sulfoisophthalic acid sodium salt |
| | 125 | g | tripropylene glycol monomethyl ether |
| | 150 | g | ethylene oxide-propylene oxide copolymer |
| | | | (Genapol PF 20) |
| | 1.00 | g | titanium tetraisopropoxide |
| | 0.05 | g | C.I. Pigment Blue 80 |

### Example 9: Polyester 9

### Reaction Conducted as per Example 1

| | | | |
|---|---|---|---|
| Components: | 280.0 | g | 1,2-propanediol |
| | 241.0 | g | ethylene glycol |
| | 582.0 | g | dimethyl terephthalate |
| | 296.0 | g | dimethyl 5-sulfoisophthalate sodium salt |
| | 143.0 | g | tetraethylene glycol monomethyl ether |
| | 0.6 | g | sodium acetate |
| | 1.00 | g | titanium tetraisopropoxide |
| | 0.05 | g | C.I. Pigment Blue 15:6 |

### Formulation Examples

### Phosphate-Containing Machine Dishwashing Detergent Powder

| | |
|---|---|
| Sodium tripolyphosphate | 43.5% |
| SKS-6 HD-D (sheet silicate) | 10.0% |
| Heavy soda | 29.5% |
| Polyester 1 | 1.00% |
| Percarbonate | 10.0% |
| TAED (Peractive CB) | 2.0% |
| Nonionic surfactant (Genapol EP 0244) | 1.5% |
| Protease (Savinase 8.0 T (Novozymes)) | 1.5% |
| Amylase (Termamyl 120 T (Novozymes)) | 1.0% |

### Reduced-Phosphate Machine Dishwashing Detergent (Tab, Multifunctional)

| | |
|---|---|
| Sodium tripolyphosphate | 24.0% |
| Soda | 33.0% |
| Polyester 4 | 1.00% |
| Disilicate | 5.0% |
| Sodium citrate | 7.2% |
| Percarbonate | 10.0% |
| TAED | 2.0% |
| Nonionic surfactant (Genapol EP 2584) | 1.5% |
| Polyglycol | 8.5% |
| Polycarboxylate | 5.0% |
| Enzymes | 2.5% |
| Perfume | 0.3% |

### Phosphate-Free Machine Dishwashing Detergent (Tab, Multifunctional)

| | |
|---|---|
| SKS-6 HD | 10.0% |
| Heavy soda | 27.5% |
| Sodium citrate | 29.5% |
| Polyester 3 | 1.00% |
| Percarbonate | 10.0% |
| TAED | 3.0% |
| Polycarboxylate | 5.5% |
| Enzymes (protease, amylase) | 3.0% |
| Genapol EP 2584 | 4.0% |
| Polyglycol | 5.2% |
| Perfume | 0.3% |

### Chlorine-Containing Machine Dishwashing Detergent for the USA:

| | |
|---|---|
| Sodium tripolyphosphate | 33.5% |
| Soda | 26.5% |
| Disilicate, amorphous or crystalline | 9.0% |
| Sodium sulfate | 26.5% |
| Polyester 1 | 1.5% |
| Nonionic surfactant (Genapol EP 0244) | 1.5% |
| Sodium dichlorocyanurate | 1.5% |

1. A colored polyester in solid form, wherein the colored polyester is obtained by polymerizing components comprising
a) one or more sulfo-free aromatic dicarboxylic acids and/or salts thereof and/or anhydrides thereof and/or esters thereof,
b) optionally one or more sulfo-containing dicarboxylic acids, salts thereof and/or anhydrides thereof and/or esters thereof,
c) one or more diols,
d) optionally one or more compounds of the formula (1)
R¹O(CHR²CHR³O)ₙH (1)
where
is a linear or branched, saturated or unsaturated alkyl group having 1 to 22 carbon atoms,
R² and R³ are each independently hydrogen or an alkyl group having 1 to 4 carbon atoms and
n is a number from 1 to 50,
e) optionally one or more compounds of the formula (2)
H—(OCHR²CHR³)ₘ—SO₃X (2)
where
R² and R³ are each independently hydrogen or an alkyl group having 1 to 4 carbon atoms and
m is a number from 1 to 10 and
X is hydrogen or an alkali metal ion, and
f) optionally one or more crosslinking polyfunctional compounds having 3 to 6 functions capable of polycondensation, especially acid, alcohol or ester functions,
with the proviso that at least one of components d) and e) is present, in the presence of
g) one or more pigment(s).

2. The colored polyester as claimed in claim 1, comprising at least one of components b) and e).

3. The colored polyester as claimed in claim 1 or 2, comprising components a), b), c), d), optionally e), optionally f), and g).

4. The colored polyester as claimed in one or more of claims 1 to 3, obtainable by polymerizing components a) to f) in the following molar ratios, based on 1 mol of component a):
0 to 4 mol, preferably 0.1 to 2 mol, especially 0.2 to 1.5 mol and most preferably 0.3 to 1.1 mol of component b),
0.1 to 4 mol, preferably 0.5 to 3 mol, especially 0.6 to 2.5 mol and most preferably 0.8 to 1.5 mol of component c),
0 to 4 mol, preferably 0.2 to 2 mol, especially 0.3 to 1.0 mol and most preferably 0.3 to 0.8 mol of component d),
0 to 4 mol, preferably 0.2 to 2 mol, especially 0.2 to .1.0 mol and most preferably 0.3 to 0.8 mol of component e),
0 to 0.2 mol, preferably 0 to 0.1 mol and especially 0 mol of component f), with the proviso that at least one of components d) and e) is present.

5. The colored polyester as claimed in one or more of claims 1 to 3, obtainable by polymerizing components a) to f) in the following molar ratios, based on 1 mol of component a):
0.1 to 2 mol, especially 0.2 to 1.5 mol and most preferably 0.3 to 1.1 mol of component b),
0.1 to 4 mol, preferably 0.5 to 3 mol, especially 0.6 to 2.5 mol and most preferably 0.8 to 1.5 mol of component c),
0 to 4 mol, preferably 0.2 to 2 mol, especially 0.3 to 1.0 mol and most preferably 0.3 to 0.8 mol of component d),
0 to 4 mol, preferably 0.2 to 2 mol, especially 0.2 to 1.0 mol and most preferably 0.3 to 0.8 mol of component e),
0 to 0.2 mol, preferably 0 to 0.1 mol and especially 0 mol of component f), with the proviso that at least one of components d) and e) is present.

6. The colored polyester as claimed in one or more of claims 1 to 3, obtainable by polymerizing components a) to f) in the following molar ratios, based on 1 mol of component a):
0.1 to 2 mol, especially 0.2 to 1.5 mol and most preferably 0.3 to 1.1 mol of component b),
0.1 to 4 mol, preferably 0.5 to 3 mol, especially 0.6 to 2.5 mol and most preferably 0.8 to 1.5 mol of component c),
0.2 to 2 mol, especially 0.3 to 1.0 mol and most preferably 0.3 to 0.8 mol of component d),
0 to 4 mol, preferably 0.2 to 2 mol, especially 0.2 to 1.0 mol and most preferably 0.3 to 0.8 mol of component e),
0 to 0.2 mol, preferably 0 to 0.1 mol and especially 0 mol of component f).

7. The colored polyester as claimed in one or more of claims 1 to 6, characterized by a number-average molar ratio in the range from 700 to 50 000 g/mol.

8. The colored polyester as claimed in one or more of claims 1 to 7, wherein component g) is a color pigment from the group of the inorganic pigments, organic pigments and effect pigments.

9. The colored polyester as claimed in one or more of claims 1 to 8, wherein component g) is an organic pigment from the group of the monoazo, disazo, laked azo, β-naphthol, naphthol AS, benzimidazolone, disazo condensation, azo metal complex pigments, phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments.

10. The colored polyester as claimed in one or more of claims 1 to 8, wherein pigment component g), based on dry pigment, is present in amounts of 10⁻⁶ to 5% by weight, preferably 10⁻⁵ to 1% by weight, more preferably 10⁻⁴ to 0.5% by weight, based on 100% by weight of colored polyester.

11. A process for producing a colored polyester as claimed in one or more of claims 1 to 10 by polycondensing components a) to f) in the presence of pigment component g).

12. The use of a colored polyester as claimed in one or more of claims 1 to 10 in washing and cleaning compositions.

13. A washing or cleaning composition formulation comprising at least 0.01% by weight, preferably between 0.1 and 10% by weight and more preferably 0.2 to 3% by weight of a colored polyester as claimed in one or more of claims 1 to 10, based on the total weight of the washing or cleaning composition formulation.
